(19) United States
(12) Patent Application Publication
(10) Pub. No.: US 2013/0152421 A1
(43) Pub. Date: Jun. 20, 2013

(54) Device and Method for Heat Treating Continuously Conveyed Sheet Materials

(71) Applicants: Paul Fricker, Wohlen (CH); Thomas Neumaier, Kleines Wiesental (DE); Andreas Maerkl, Lorrach (DE); Thomas Wegmann, Hasel (DE)

(72) Inventors: Paul Fricker, Wohlen (CH); Thomas Neumaier, Kleines Wiesental (DE); Andreas Maerkl, Lorrach (DE); Thomas Wegmann, Hasel (DE)

(73) Assignee: BENNINGER ZELL GMBH, Zell i.W. (DE)

(21) Appl. No.: 13/519,965

(22) PCT Filed: Dec. 30, 2009
(86) PCT No.: PCT/EP2009/068033

§ 371 Date: Aug. 3, 2012

(51) Int. Cl. F26B 3/00

(52) U.S. Cl. CPC F26B 3/00
USPC 34/412; 34/92

(57) ABSTRACT

The invention relates to a device for performing heat treatments comprising at least one treatment module (10), which has a first and a second heating section (11a, 11b). Hot air (L) is introduced into the heating sections (11a, 11b) via a line connection (13). After the treatment, the hot air (L) is discharged via suction means (14). The suction means are arranged at the end faces of the heating sections (11a, 11b).

The invention relates to a device and a method for the heat treatment of continuously conveyed sheet-like structures. The device and method are suitable particularly for the heat treatment of a warp or of an elongate textile sliver. Heat treatment may be, for example, drying and/or drafting of a previously treated thread or fabric. In the production of tire cord, for example, the fabric impregnated with an adhesion promoter has to be led through a dryer. Moreover, the plastic fibers are subsequently drafted.

A device for the heat treatment of tire cord products became known, for example, from DE 2 108 263 A. The device shown there has a plurality of modules which are arranged next to one another and through which the material to be treated is led in a meander-like manner in loops. Each module has a system for feeding and discharging hot gas into and out of a heating chamber. Two inlets for the hot gas and one outlet arranged at the upper end of a module tower are provided for each module.

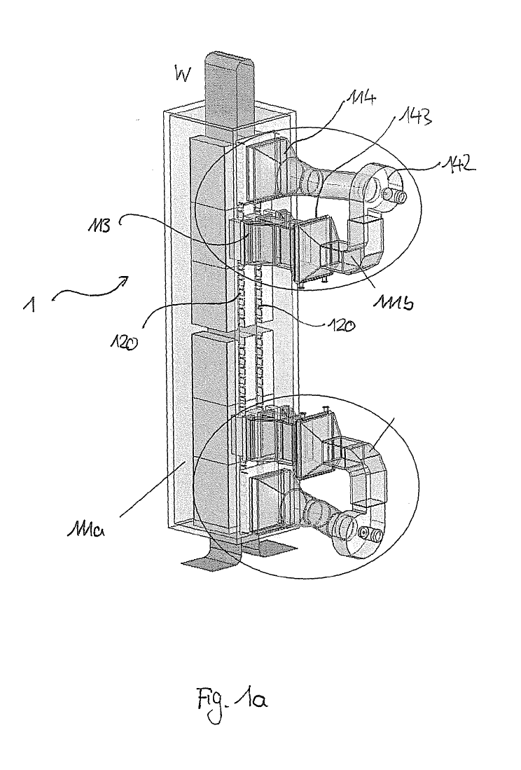

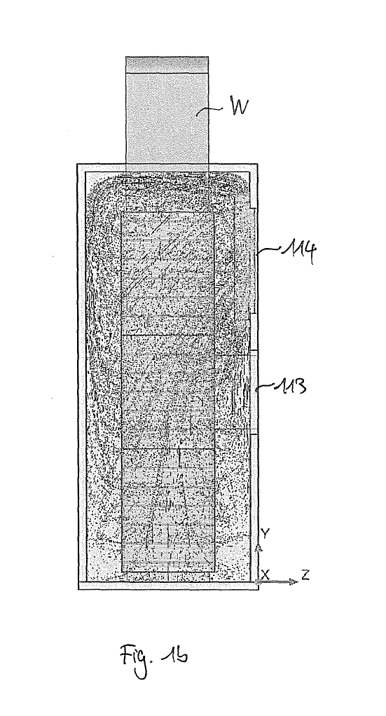

Moreover, devices are known in which heating sections, each with three nozzle boxes, are present. Hot air is introduced laterally into a middle nozzle box. The exhaust air is sucked away again laterally in an upper or a lower nozzle box section (see also the illustration in FIG. 1a).

In practice, these arrangements have various disadvantages. Thus, unfavorable flow conditions may arise in the heating chambers, and this may lead to a final product of deficient quality. Especially when uneven temperature distributions arise in the heating chambers, this may lead to product properties distributed unevenly over the width of the sliver. Especially when lower airflows prevail in regions (see, for example, the lower region in FIG. 1b), poorer energy transmission occurs in these regions.

Moreover, in particular, lightweight slivers can be moved transversely with respect to the transport direction on account of a cross flow (see also FIG. 1b). As a result of this creasing, as it is known, the sliver is unintentionally deformed. Nevertheless, on the basis of experience, sufficiently uniform treatment can be achieved in individual cases by a deliberate setting of air quantities and temperature as a function of the product treated in each case and of the coating materials used in each case. Since a multiplicity of products having different product properties are to be treated to an increased extent on existing devices, however, individual adaptation proves to be difficult.

Another problem is that, on account of process-related dryer heights, above all lightweight material is excited to oscillate over the free length. This fluttering may lead to undesirable contact with the mechanical parts of the dryer and cause damage to the material. In such a case, with existing dryers, only the plant speed can be minimized, which, in turn, results in a loss of plant productivity.

A further problem in known devices is that the heating energy employed cannot be utilized optimally. Energy costs make up the main constituent of the production costs in such treatment devices. Finally, a problem in known devices is also that they require a large closed-in space, that likewise increases the investment costs.

An object of the present invention, therefore, is to avoid the disadvantages of the prior art and, in particular, to provide a device and a method, in which the process conditions in the heating chambers can be controlled accurately and which can nevertheless be used universally for a multiplicity of different process conditions. Thus, for example, different coatings in respect of their chemical composition and different types of sheet-like structures made from different materials should be able to be treated by means of the same device. The device is then to be distinguished by a low energy demand and low space requirement, fluttering and creasing even of lightweight fabrics are to be prevented and homogeneous energy transmission in the entire heating chamber is to be achieved.

These objects are achieved, according to the invention, by means of a device and by means of a method having the features of the preamble of the independent claims.

According to a first aspect of the present invention, the device for heat treatment has at least one treatment module. The device serves for the heat treatment and, in particular, for the drafting of continuously conveyed sheet-like structures. Such sheet-like structures are typically a warp or a textile sliver, in particular tire cord or conveyor belt fabric. In addition to drying, the device is also used in a way known per se for the drafting of plastic fibers.

The treatment module has at least one heating section. The sliver can be led along a transport path approximately vertically through at least one heating chamber of this heating section. The guidance of the sliver takes place approximately vertically in an upward direction and optionally, after it passes through a deflection means, in a downward direction through a further heating chamber of the heating section. The cloth is typically deflected via a roller for looped material guidance.

The heating section has at least one line connection for feeding a heating medium into the heating chamber. The heating medium is typically hot air. Moreover, the heating section has suction extraction means for discharging the heating medium out of the heating chamber. In addition to the exhaust air, if appropriate, substances emitted from the coating of the sliver, such as, for example, smoke-generating exhaust gases, can also be discharged.

The line connection is connected to at least one nozzle box which extends in the transport direction and transversely thereto. Typically, by means of the nozzle box, air is injected uniformly, over the entire width of the sheet-like structure into the heating chamber approximately perpendicularly to the sheet-like structure.

According to the invention, the suction extraction means are arranged essentially symmetrically with respect to the transport path and/or at one end of the heating section. By virtue of this arrangement at the end of the heating section, the air injected into the heating chamber is distributed essentially homogeneously in the heating chamber and is guided, parallel to the sheet-like structure or the sliver, in an essentially laminar flow in the direction of the end of the heating section or of the heating chamber. The end of the heating section is understood in this context to mean both an entry end and an exit end for the sheet-like structure. The suction extraction means is typically arranged in each case at that end of a heating section in which the sheet-like structure is delivered to or discharged from the device or is delivered via a deflection arrangement to a further following treatment module or from a preceding treatment module.

The nozzle boxes are arranged in each case laterally with respect to the transport path of the sheet-like structure, so that a heating chamber is formed between two adjacent nozzle boxes. The nozzle boxes are otherwise designed in a way known per se.

Excitation to oscillation or fluttering of the fabric web is greatly reduced by the established flow being essentially laminar.

Since the air moves symmetrically or parallel to the cloth run, there is also less risk of creasing because transverse force no longer acts upon the sliver.

According to a preferred embodiment, two heating sections are provided in each treatment module, a second heating section being provided above a first heating section, so as to give rise to a vertical transport path, running through the two heating sections, parallel to the sliver through the treatment module. In this case, the suction extraction means of the lower heating section are arranged at the lower or bottom-side end of the heating section. The suction extraction means of the upper heating section are arranged at the upper end of the heating section and therefore also of the treatment module. By the air being suction-extracted in these marginal regions, energy efficiency is improved, since this prevents hot exhaust air from passing into the surroundings.

Especially preferably, the suction extraction means are formed by suction extraction bodies which project into the heating chambers and which have at least one suction extraction port. By means of such specially configured additional suction extraction bodies, the flow of air within the heating chamber can be deliberately influenced so that, as far as possible, no dead corners occur and such that the airflow is as laminar as possible and runs parallel to the cloth run. A dead corner is understood in this context to mean a region in the heating chamber in which no or only insignificant air movement occurs and in which another, typically lower temperature would accordingly prevail.

Especially preferably, a suction extraction body is provided on each side of the transport path or of the sheet-like structure. Especially preferably, in the case of a treatment module with a transport path running vertically upward and a transport path running vertically downward parallel to it, three suction extraction bodies arranged next to one another are provided. The sliver is then led in each case in a gap space through between two adjacent suction extraction bodies in each case. If three nozzle boxes arranged next to one another are present in a heating section and define two heating chambers, preferably in each case each nozzle box is assigned a suction extraction body. Nozzle boxes which blow the air toward the sliver on one side are provided with a suction extraction body which also sucks in the air again from one side. Nozzle boxes which on both sides direct air against a sliver, for example a sliver guided upward in the vertical direction on one side and a sliver guided downward in the vertical direction on the other side, are provided with a suction extraction body which sucks away air from two sides. This ensures that air routing within a heating chamber is homogeneous and that homogeneous air routing and therefore temperature distribution prevail in a heating chamber even on both sides of the sliver.

The suction extraction body is preferably of box-shaped design. It typically is a rectangle in profile cross section. Such suction extraction bodies can be produced simply and, moreover, are adapted in their shape to the surface of the sliver led past. The suction extraction body typically has an approximately straight region and an entry region, adjoining the latter, with a widening flow cross section. The entry region adjoins the suction extraction means and a corresponding line connection. Suction extraction ports are arranged in the box-shaped suction extraction body in the sidewalls running in the transport direction and/or in further boundary surfaces. Designing the suction extraction body as a box with sidewalls allows suction extraction ports to be freely positioned. Tests can in this case make it possible to find an optimal arrangement of the suction extraction ports for generating as homogeneous and as laminar an airflow as possible. Ports prove to be especially suitable which are arranged as long holes in the sidewall adjacently to the end face facing the line connection and in an endwall facing away from the line connection. An additional port in the entry region having the widening flow cross section is likewise preferred. It is conceivable, however, that other suction extraction ports likewise bring about the desired effect of as laminar a flow as possible and as uniform a temperature distribution as possible.

The suction extraction body extends transversely with respect to the transport direction over at least 80% of the width of the sliver into the heating chamber. The suction extraction body preferably extends over the entire width of the treatment module.

A further aspect of the invention relates to a device for heat treatment, with at least one treatment module which has a first heating section and a second heating section arranged above the first heating section. Each heating section has a line connection for feeding a heating medium and suction extraction means for discharging the heating medium out of the heating section. According to the invention, the suction extraction means of the first heating section are connected via a line to the line connection for feeding a heating medium of the second heating section. The suction extraction means of the second heating section are connected via a line to the line connection for feeding a heating medium of the first heating section. This crosswise connection of the first and of the second heating section achieves as homogeneous a distribution of the temperature as possible in the two heating sections of a heating module. At the same time, the concentration of, for example, solvents in the two heating sections is kept as identical as possible, so that essentially identical process conditions prevail. The line connections are preferably in each case preceded by a blower unit, by means of which the air is conveyed out of one heating section into the other heating section. The lines which connect the two heating sections to one another are in this case preferably arranged on the same side of the treatment module, specifically, in particular, on a side wall which stands transversely to the sliver or to the transport path. Different treatment modules can thus be arranged compactly next to one another. The lines connecting the individual heating sections project laterally from the modules in only one direction. The space requirement is consequently reduced.

The natural convection in the mainly vertically arranged heating zones ensures a colder region at the lower end of the heating zone and a warmer region at the upper end of the heating zones. As a result of the crosswise arrangement of suction extraction and the injection, the temperature difference occurring due to convection between top and bottom is homogenized.

While such a crosswise connection of the air feed and air discharge of the individual heating sections is already advantageous in itself, this type of air routing is especially advantageous in combination with the above-described arrangement of air discharge on the end faces and with suction extraction bodies. By virtue of this combination, a further unification of the process conditions and more homogeneous temperature distribution can be achieved.

Yet another aspect of the invention relates to a device for the heat treatment and, in particular, for the drying and drafting of continuously conveyed sheet-like structures, in particular a warp or textile sliver. The device has at least one treatment module with at least one heating section. The sliver can be led for the purpose of treatment through the treatment module and through the heating section. The heating section has at least one line connection for feeding a heating medium, in particular heating air, into at least one heating chamber. The line connection is provided with a blower unit for conveying the hot air. The line connection is connected to at least one nozzle box, via which the heating medium can be introduced into the heating chamber. According to the invention, a heat exchanger is arranged on the pressure side between the blow unit and the line connection. The heat exchanger may, for example, be a directly heating burner arrangement operating with gas or light fuel oil or with other fuels or an indirectly operated heat exchanger device through which treatment fluid flows. It was shown that, by the heat exchanger being arranged on the pressure side between the nozzle boxes and the blower, much more homogeneous air distribution can be achieved in the nozzle box and subsequently in the heating chambers. The heat exchanger has in this case a laminarizing effect upon the air flowing through. Admittedly, by the heat exchanger being installed on the pressure side, the velocity of the airflow is somewhat reduced. Instead, a dynamic pressure is built up which leads to uniform velocity distribution in the air after it leaves the heat exchanger and which thereby achieves uniform heat transfer over the entire heat exchanger cross section. This aspect of the invention, too, is preferred in itself, but may especially advantageously be combined in combination with the above-described measures for improving the uniformity of air distribution. On account of the more regular velocity distribution, better heat transmission occurs. This results in higher efficiency of the heat exchanger.

A plurality of treatment modules may be arranged next to one another. In this case, the sliver can be conveyed by upper and lower deflection means in each case in a meander-like manner in loops through the device from one module to the next module.

The components, such as blower, heat exchanger and lines, used in the individual treatment modules lying next to one another may in this case be in each case designed identically. Since the air distribution and temperature distribution in the individual heating chambers are homogeneous due to the structural measures taken, further modifications or adaptations to the air guide elements in order to bring about this desired homogenization are not necessary. The measures according to the invention therefore make it possible to provide a modular type of construction which by means of a few standardized components enables universally usable devices to be provided, even in terms of economic factors.

A further aspect of the invention relates to a method for the heat treatment and, in particular, for the drying or drafting of continuously conveyed sheet-like structures. The method is typically carried out, using a device as described above. The sheet-like structure is preferably led approximately vertically in an upward direction and optionally, after passing through a deflection means, in a downward direction through at least one heating section of a treatment module. In this case, the sheet-like structure is acted upon via a heating medium. The sheet-like structure is introduced via a nozzle box into at least one heating chamber of the heating section. According to the invention, the heating medium is subsequently sucked away via a suction extraction means arranged on an end face of the heating section, such that homogeneous temperature distribution and laminarized flow parallel to the sliver direction occur over the width of the sheet-like structure and an airstream running in the conveying direction, that is to say in the upward or the downward direction, is generated.

Yet another aspect of the invention relates to a method for the heat treatment and, in particular, for the drying of continuously conveyed sheet-like structures, particularly using a device as described above. In this case, the sheet-like structure is preferably led approximately vertically in an upward direction and optionally, after passing through the deflection means, in a downward direction through two successively connected heating sections of a treatment module. According to the invention, the air discharged out of one heating section via a suction extraction means is heated again via a heat exchanger and is fed again in each case to the other heating section via a line connection.

Yet a further aspect of the invention relates to a method for the heat treatment and, in particular, for the drying of continuously conveyed sheet-like structures, particularly using a device as described above. In this case, the sheet-like structure is led through at least one heating chamber of a treatment module. According to the invention, a heating medium is introduced by means of a blower through a heat exchanger and then in to the heating chamber. In this case, the heat exchanger is arranged on the pressure side between the blower and the heating chamber. An especially uniform introduction of the hot air into the heating chamber can consequently be achieved.

The invention is explained in more detail below by means of the drawings and in exemplary embodiments. In the drawings:

FIG. 1a shows a perspective illustration of a treatment device with air feed and air discharge according to the prior art,

FIG. 1b shows an arithmetic determination of the air velocity in the heating chamber according to FIG. 1a,

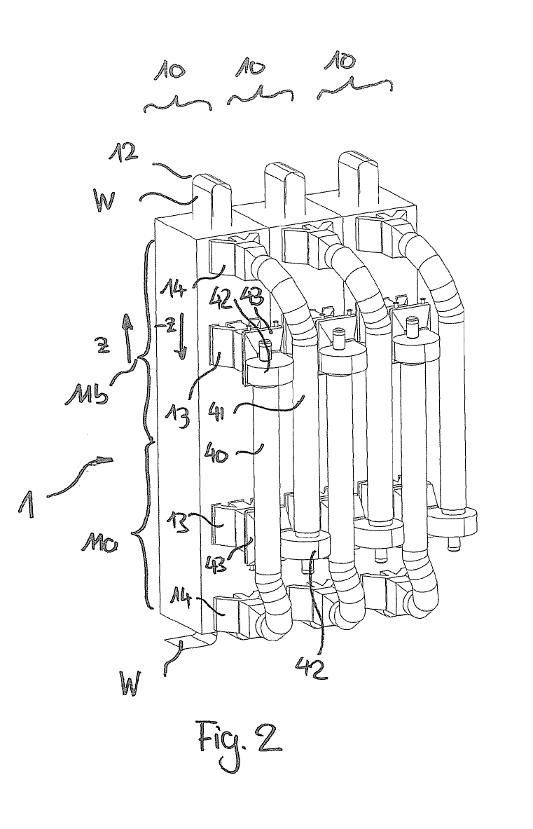

FIG. 2 shows a perspective illustration of an arrangement according to the invention with three treatment modules according to the present invention,

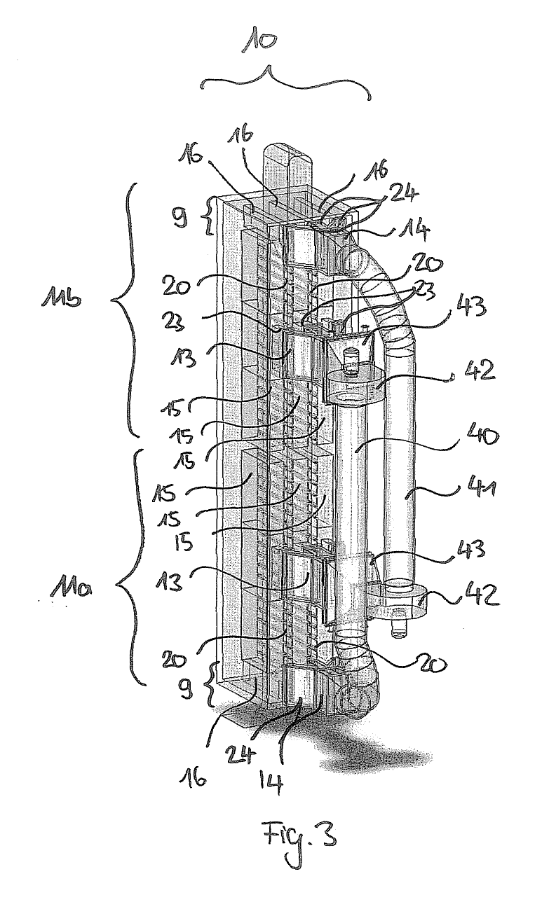

FIG. 3 shows an individual treatment module of the device according to FIG. 2 with the housing illustrated transparently,

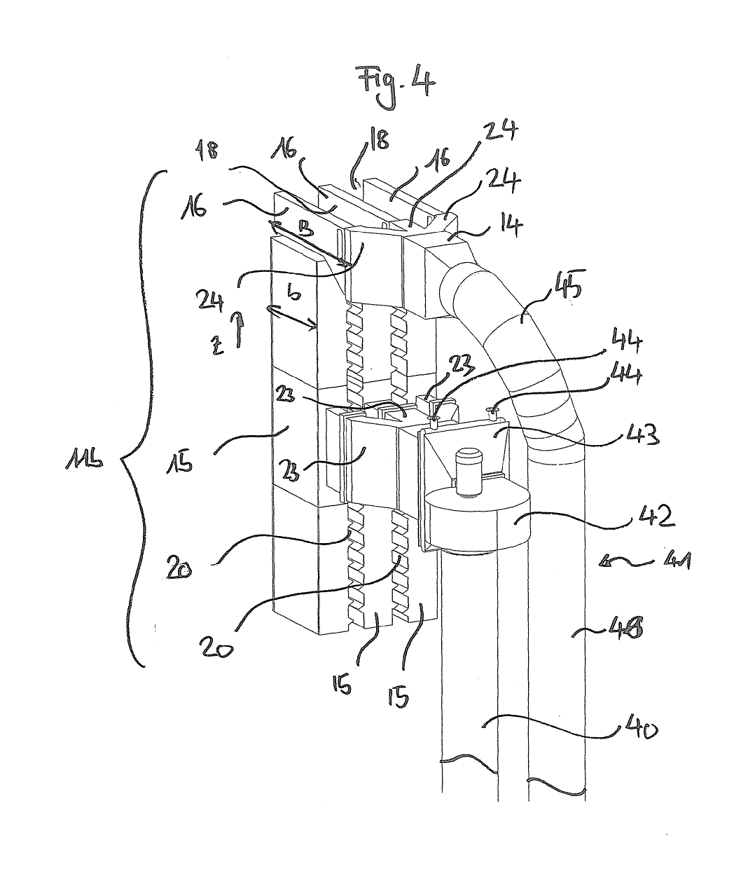

FIG. 4 shows a detailed illustration of the air routing in an upper heating section of the treatment module according to FIG. 3 (with housing cover parts being omitted),

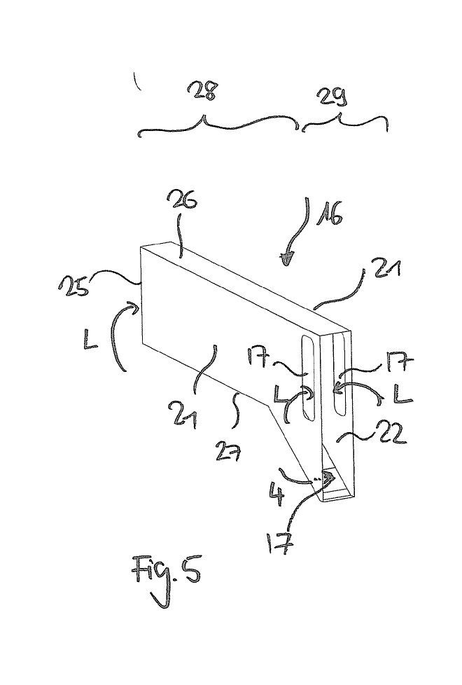

FIG. 5 shows a perspective illustration of a suction extraction body according to the invention,

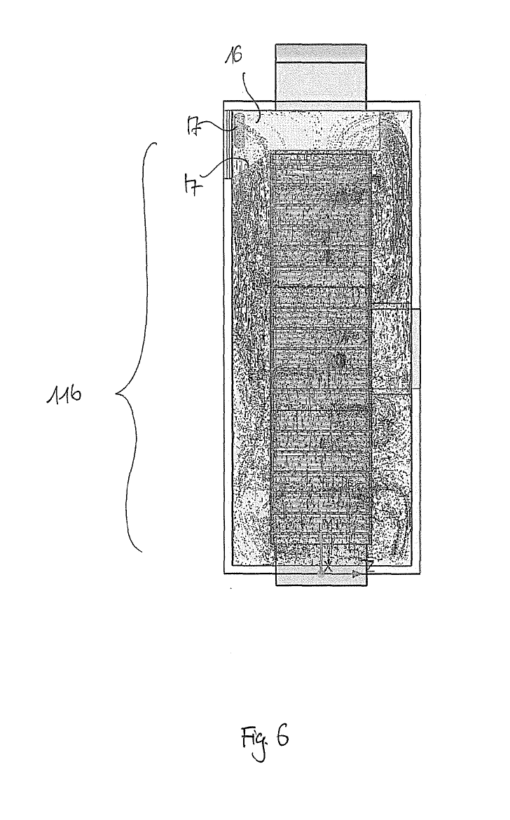

FIG. 6 shows a diagrammatic illustration of the airflow and temperature distribution in a device according to FIG. 3,

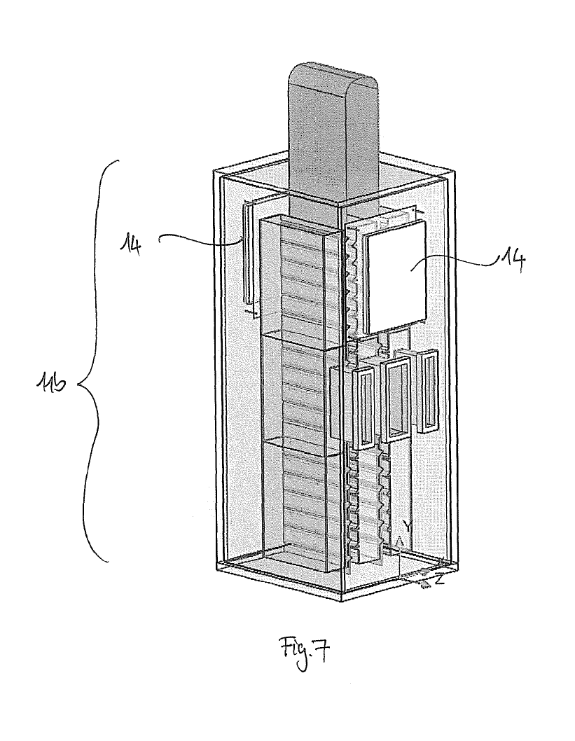

FIG. 7 shows an illustration according to a first alternative embodiment,

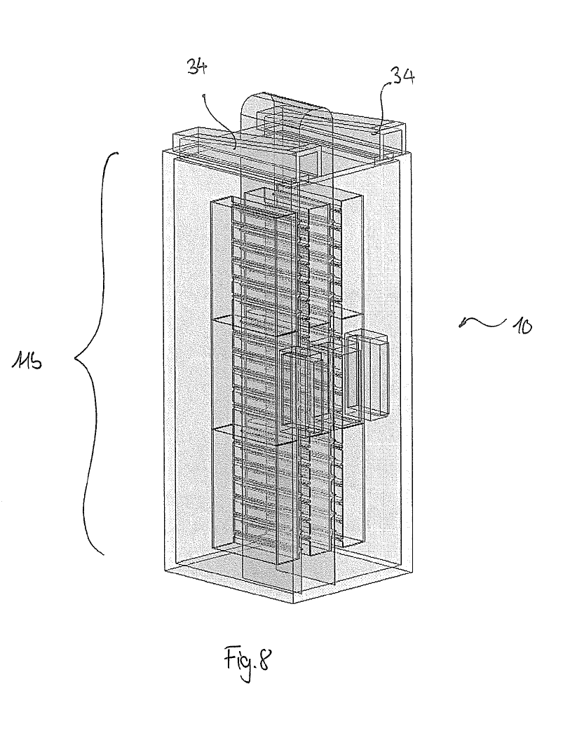

FIG. 8 shows an illustration according to a second optimized embodiment,

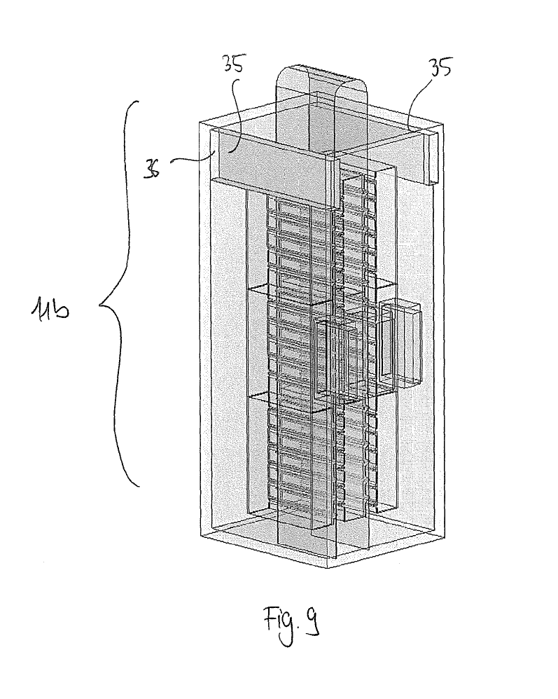

FIG. 9 shows an illustration according to a third, further optimized embodiment,

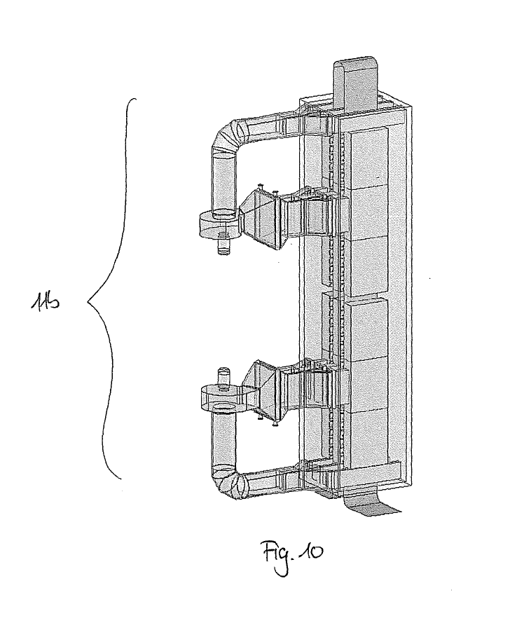

FIG. 10 shows an illustration according to a further alternative embodiment.

FIG. 1 shows an embodiment, made known by the applicant, of the air feed and air discharge of the prior art. A dryer 101 has a lower heating section 111a and an upper heating section 111b. In the heating sections 111a, 111b, in each case two heating chambers 120 are formed, through which a sliver W is led in the vertical direction upward and downward. Hot air is fed to the heating chambers via a central line connection 113 and is discharged again via a suction extraction line 114. The suction extraction line 114 issues laterally into the heating section. According to FIG. 1a, in contrast to known arrangements, a heat exchanger 143 is arranged on the pressure side of a fan 142. The velocity distribution of the air is illustrated in FIG. lb by arithmetic determination. Dead spaces are present at the upper end in the corners of the heating chamber. Moreover, an airflow in the direction of the connection 114 can be seen. This airflow gives rise to transverse forces upon the fabric, which leads to creasing. In contrast to the prior art, the illustration in FIG. la has a heat exchanger 143 arranged upstream of a blower on the pressure side.

FIG. 2 shows diagrammatically a dryer 1 according to the invention. A sliver W is fed to the dryer device 1 by preceding treatment arrangements (in particular, an impregnating bath), not illustrated in any more detail. The dryer device 1 is composed of three treatment modules 10 arranged next to one another. The sliver W is led in each case through each treatment module 10 vertically upward in an upward direction z. After leaving the treatment module 10, the sliver W is deflected around a deflecting roller 12 (not illustrated in detail) and is led through the treatment module 10 vertically again in a downward direction −z. After leaving the first treatment module 10, the sliver is led anew at the lower end around a deflecting roller (not illustrated) and is fed to the adjacent following treatment module. Each treatment module has a first lower heating section 11a and a second upper heating section 11b. each heating section 11a, 11b is provided with a suction extraction line 14 and with a line connection 13 for feeding heating air. The suction extraction lines are in each case arranged at the lower and at the upper end of the treatment module 10. The line connection 13 for injecting warm air into the upper heating section 11b is connected via a line 40 to the suction extraction line 14 of the lower heating section 11a. The line connection 13 for injecting hot air into the lower heating section 11a is connected via a line connection 41 to the suction extraction line 14 of the upper heating section 11b. Air circulation between the two heating sections 11a, 11b is thus obtained.

The line connections 13 and the suction extraction lines 14 are in this case arranged on the housing of the treatment modules 10 laterally, that is to say on the side faces perpendicular to the sliver. The pipelines 40, 41 and line connections 13 and suction extraction lines 14 consequently all project in the same direction, so that the three treatment modules illustrated in FIG. 2 can be arranged closely next to one another. As a result, on the one hand, energy (because the individual modules as it were insulate one another) and, on the other hand, space are saved.

The hot air is injected into the heating sections 11a, 11b by means of a blower 42. A heat exchanger 43 is arranged on the pressure side of the blower between the blower and the line connection 13. On account of this arrangement, uniform air distribution can be achieved even with a very short pipe length between the fan 42 and line connection 13. The device 1 can consequently have a space-saving build. The device shown in FIG. 2 is typically used for the treatment of tire cord. Tire cord is a fabric made from plastic fibers (for example, from polyamide or polyester with fabric widths usually up to 1500 mm-approximately 3000 mm). The fabric is treated, depending on the material, in one to two treatment steps with isocyanates and with a resorcinol formaldehyde latex. The tire cord is led at a typical speed of approximately 80 m/min to 120 m/min through the treatment modules 10 which typically have a height of approximately 10-approximately 20 meters. A temperature of 140-230° C. typically prevails in the individual heating sections 11a, 11b. The sliver is led through the heating sections 11a, 11b with a tension of up to 11 to. The treatment has an air quantity of up to 150000 m̂3/h typically introduced for each heating section 11a, 11b by means of the blower.

FIG. 3 shows an individual treatment module 10, the housing of the device being illustrated transparently. The same reference symbols designate in FIG. 3 the same elements as in FIG. 2. Each heating section 11a, 11b has three rows, lying next to one another, of nozzle boxes 15. In each case a heating chamber 20 (see also FIG. 4) is formed between nozzle boxes lying next to one another. In a treatment module 10 according to FIG. 3, the sliver is led successively through a first heating chamber 20 in the lower heating section 11a, through a first heating chamber 20 of the upper heating section 11b, through a second heating chamber 20 of the upper heating section 11b and through a second heating chamber of the lower heating section 11a. Each of the three nozzle boxes 15 is acted upon with hot air from the line connection 13. For this purpose, the line connection 13 has a branch into three individual feed connection pieces 23.

Suction extraction bodies 16 are arranged in the entry region on the end face 9 of the module. Each nozzle box 15 is assigned a suction extraction body 16. The suction extraction line 14 has a branch into three suction extraction connection pieces 24, in each case a suction extraction connection piece 24 being assigned a suction extraction body 16. FIG. 4 shows the air routing in the upper heating section 11b in more detail, with the housing being omitted. The air routing in the lower heating section 11a is designed essentially identically, but mirror-symmetrically. The same reference symbols once again designate identical parts. The three suction extraction bodies 16 are designed identically. They are arranged on the end face above the nozzle boxes 15 in the upward direction z and so as to adjoin these. Each of the suction extraction bodies 16 is connected via the discharge connection piece 24 assigned to it to the suction extraction line 14. The suction extraction line 14 is connected via a curved line piece 45 to the straight line piece 46 of the line 41.

The heat exchanger is designed as a fluid heat exchanger, a heating fluid being fed and being discharged again via connections (44). The fan (42) is typically a radial air blower with lateral blow-out. The nozzle boxes (15) are designed in a way known per se. The middle nozzle box has on both sides nozzle ports directed outward. The in each case outer nozzle boxes 15 have only inwardly directed nozzle ports. The sliver led through the heating chambers 20 formed between the nozzle boxes is in this case acted upon with hot air from both sides.

Between the suction extraction bodies 16, gaps spaces 18 are formed, through which the sliver W is led. Since a suction extraction body 16 is assigned to each nozzle box 15, a suction extraction of warm air from both sides of the sliver is produced over the entire width of the latter. The suction extraction body 16 has a width B which corresponds at least to the width b of the nozzle boxes.

FIG. 5 shows an enlarged illustration of suction extraction body 16. The suction extraction body 16 is designed as a box and has two sidewalls 21. The sidewalls 21 delimit the transport path for the sliver. The suction extraction body 16 has an open end face 22 which faces the suction extraction connection piece 24. Moreover, the suction extraction body 16 has a further end face 25 which is designed to be open and through which hot air L is sucked away in the direction of the arrow. Finally, the box of the suction extraction body 16 is closed off by an upper wall 26 and by a lower wall 27. The upper wall 26 is designed to be closed. The suction extraction body 16 has a first region 28 which has essentially a constant cross section. Moreover, the suction extraction body 16 has toward the end face 22 an entry region 29 widening in cross section. Suction extraction ports are arranged in the entry region 29. Two suction extraction ports 17 designed as a long hole are arranged in the sidewalls 21 and a suction extraction port 17 of essentially square form is arranged in the lower wall 27. Hot air L passes through these ports into the suction extraction body 16 in the direction of the arrow and is led from the latter through the suction extraction connection pieces 24 to the suction extraction line 14.

FIG. 6 shows the velocity distribution in the upper heating section 11b in a section along the sliver. In the region in which the sliver is acted upon by warm air, an essentially uniform velocity distribution prevails. Moreover, the velocity is relatively low. As a result, homogeneous temperature distribution is obtained, and no dead zones occur.

FIG. 7 shows a first alternative embodiment by the example of the upper heating section 11b. The air is introduced, as shown in FIGS. 2-4. However, suction extraction takes place symmetrically via two laterally arranged suction extraction lines.

FIG. 8 shows a further alternative embodiment by the example of the upper heating section 11b. The air is sucked away via two suction extraction connection pieces 34 arranged at the upper end of the treatment module 10.

FIG. 9 shows a further optimized version of the suction extraction. Suction extraction boxes 35 are introduced, parallel to the sliver, into the lateral boundary walls at the upper end adjacently to the nozzle boxes. Transverse forces upon the cloth therefore do not occur. The suction extraction boxes 35 have perforated sidewalls 36 through which the air is sucked away.

FIG. 10 shows a further-optimized embodiment. According to FIG. 10, the suction extraction lines 14 are arranged on the end faces of the treatment module 1. In contrast to the illustration in FIG. 2, here, the discharge lines and feed lines for the hot air are not led crosswise between the lower heating section 11a and the upper heating section 11b.

1-17. (canceled)

18. A device for the heat treatment and, in particular, for the drying of continuously conveyed sheet-like structures, in particular a warp or a textile sliver, with at least one treatment module having at least one heating section, through which the sliver can be led along a transport path approximately vertically in at least one of an upward direction and in a downward direction,
the heating section having at least one line connection for feeding heating medium, in particular hot air into at least one heating chamber of the heating section, and
having suction extraction means for discharging the heating medium out of the heating chamber,
and the at least one line connection being connected to at least one nozzle box which extends in the transport direction and transversely thereto and via which the heating medium can be introduced into the heating chamber,
wherein the suction extraction means are arranged with respect to the transport path essentially in such a way that an air flow running parallel to the sliver essentially in the transport direction is obtained, and in that, in particular, the suction extraction means are arranged at least one of symmetrically and at one end of the heating section, preferably directly adjacently to the nozzle boxes.

19. The device as claimed in claim 18, wherein a second heating section arranged above the first heating section is provided for each treatment module, each heating section having a line connection for feeding a heating medium and suction extraction means for discharging the heating medium out of the heating chamber, and the suction extraction means assigned to the lower heating section being arranged at the lower or bottom-side end of the heating section and the suction extraction means assigned to the upper heating section being arranged at the upper end of the heating section.

20. The device as claimed in claim 18, wherein the suction extraction means contain a suction extraction body projecting into the heating chamber and provided with at least one suction extraction port.

21. The device as claimed in claim 20, wherein at least one suction extraction body is provided on both sides of the transport path.

22. The device as claimed in claim 20, wherein three suction extraction bodies arranged next to one another are provided for each heating section, the sliver in each case being capable of being led in a gap space through between in each case two adjacent suction extraction bodies, in particular each nozzle box being assigned in each case a suction extraction body.

23. The device as claimed in claim 20, wherein the at least one suction extraction body is of box-shaped design, the suction extraction body preferably being rectangular in profile cross section.

24. The device as claimed in claim 23, wherein the at least one suction extraction body has an approximately straight first region and an entry region adjoining the latter and having a widening flow cross section.

25. The device as claimed in claim 20, wherein the at least one suction extraction body has sidewalls running approximately in the transport direction and an end face facing the suction extraction line, and wherein at least one of the sidewalls and further walls of the suction extraction body are provided with the suction extraction ports.

26. The device as claimed in claim 20, wherein the at least one suction extraction body extends transversely with respect to the transport direction over at least 80% of the entire width of the sliver into the heating chamber, preferably over the entire width.

27. The device for the heat treatment and, in particular, for the drying of continuously conveyed sheet-like structures, in particular a warp or a textile sliver, in particular as claimed in claim 18, with at least one treatment module having a first heating section and a second heating section arranged above the first heating section, each heating section having a line connection for feeding a heating medium and suction extraction means for discharging the heating medium out of the heating section, wherein the suction extraction means of the first heating section are connected via a line to the line connection of the second heating section, and in that the suction extraction means of the second heating section are connected via a line to the line connection of the first heating section.

28. The device as claimed in claim 27, wherein the line connections are preceded in each case by a blower unit.

29. The device as claimed in claim 28, wherein the lines are arranged on the same side of the treatment module laterally in relation to the transport path.

30. The device for the heat treatment and, in particular, for the drying of continuously conveyed sheet-like structures, in particular a warp or a textile sliver, with at least one treatment module having at least one heating section, through which the sliver can be led,
the heating section having at least one line connection and one blower unit for feeding a heating medium, in particular hot air, into at least one heating chamber, and
the at least one line connection being connected to at least one nozzle box, via which the heating medium can be introduced into the heating chamber, wherein a heat exchanger is arranged on the pressure side between the blower unit and the line connection.

31. The device as claimed in claim 18, wherein a plurality of treatment modules arranged next to one another are present, and in that the sliver can be led by upper and lower deflection means in a meander-like manner in loops through the device.

32. A method for the heat treatment and, in particular, for the drying of continuously conveyed sheet-like structures, in particular a warp or a textile sliver in which the sheet-like structure is led preferably approximately vertically in an upward direction and/or, after passing through a deflection means, in a downward direction through at least one heating section of a treatment module,
the sheet like structure being acted upon by a heating medium which is introduced via a nozzle box into at least one heating chamber of the heating section, wherein the heating medium is sucked away via a suction extraction means arranged, in particular, on an end face of the heating section, such that an air stream running essentially in a conveying direction is generated over the width of the sheet-like structure.

33. A method for the heat treatment and, in particular, for the drying of continuously conveyed sheet-like structures, in particular a warp or a textile sliver,
in which the sheet-like structure is led preferably approximately vertically in an upward direction and/or, after passing through a deflection means, in a downward direction through two successively arranged heating sections of a treatment module, wherein the air discharged out of one heating section via a suction extraction means is heated via a heat exchanger and is fed to the other heating section again via a line connection.

34. A method for the heat treatment and, in particular, for the drying of continuously conveyed sheet-like structures, in particular a warp or a textile sliver in which the sheet-like structure is led through at least one heating chamber of a treatment module, wherein a heating medium is routed by means of a blower through a heat exchanger into the heating chamber.

35. The device as claimed in claim 27, wherein a plurality of treatment modules arranged next to one another are present, and in that the sliver can be led by upper and lower deflection means in a meander-like manner in loops through the device.

36. The device as claimed in claim 30, wherein a plurality of treatment modules arranged next to one another are present, and in that the sliver can be led by upper and lower deflection means in a meander-like manner in loops through the device.
